(19) United States
(12) Patent Application Publication
(10) Pub. No.: US 2022/0274660 A1
(43) Pub. Date: Sep. 1, 2022

(54) Protective Cover for Motorcycle Seat

(71) Applicant: TSAI-HUI CHEN, Pingtung County (TW)

(72) Inventor: TSAI-HUI CHEN, Pingtung County (TW)

(21) Appl. No.: 17/188,122

(22) Filed: Mar. 1, 2021

(51) Int. Cl. B62J 1/18; B62J 11/24

(52) U.S. Cl. CPC B62J 1/18; B62J 11/24

(57) ABSTRACT

A protective cover for motorcycle seat comprises mainly a retaining frame and a cover body connected thereto; wherein the retaining frame is arranged according to the shape and size of the motorcycle seat, and the cover body may be of various colors and have various designs; the cover body is of a substantially semi-circular shape thereon are disposed a plurality of support rods, and two ends of the plurality of support rods are respectively positioned at central positions of the retaining frame so that the cover body may be pulled to open or to close and cover the retaining frame and form a storage space. The protective cover is fixed on the motorcycle seat by the retaining frame. When the motorcycle is not in use, the cover body provides protection against sun, rain and dust, a safe storage space for helmets, and a color that marks out the motorcycle for easy location.

### BACKGROUND OF THE INVENTION

### 1. Field of the Invention

The present invention relates to a protective cover for motorcycle seat, and particularly to a protective cover for motorcycle seat that provides protection against sun, rain and dust, a safe storage space for helmets, and a color that marks out the motorcycle for easy location.

### 2. Description of Related Art

As motorcycles are mostly parked outdoors, their seats are easily damaged due to long exposure to sun, rain and dust. They are also susceptible to vandalism, and scorching summer heat may raise their temperature to a degree that poses burn danger to a user's hip. Further, many users are in the habit of hanging their helmets on the handles or put them on the seats after parking their motorcycles, taking no precautions against rain or theft. In addition, when parked in a large parking lot among hundreds of motorcycles of the same brands and types, they are not easy for their users to locate unless having a special and unique color or design.

In view of this, after laborious research and experiments, the applicant has devised a protective cover for motorcycle seat that provides protection against sun, rain and dust, a safe storage space for helmets, and a color that marks out the motorcycle for easy location.

### SUMMARY OF THE INVENTION

It is a primary objective of the present invention to provide a protective cover for motorcycle seat that provides protection against sun, rain and dust, a safe storage space for helmets, and a color that marks out the motorcycle for easy location.

A foregoing protective cover for motorcycle seat comprises a retaining frame and a cover body connected thereto; wherein the retaining frame is arranged according to the shape and size of the motorcycle seat, and the cover body may be of various colors and have various designs; the cover body is of a substantially semi-circular shape thereon are disposed a plurality of support rods, and two ends of the plurality of support rods are respectively positioned at central positions of the retaining frame so that the cover body may be pulled to open or to close and cover the retaining frame and form a storage space. The protective cover is fixed on the motorcycle seat by the retaining frame. When the motorcycle is not in use, the cover body provides protection against sun, rain and dust, a safe storage space for helmets, and a color that marks out the motorcycle for easy location.

A foregoing protective cover for motorcycle seat, wherein at central positions of two sides of the retaining frame is disposed an axial part fixed on the retaining frame. Two ends of the plurality of support rods are respectively positioned at the axial part so that the cover body may use the axial part as a pivot. One end of the cover body is fixed at a fixed end of the retaining frame, whereas another end is an open movable end so that the cover body may be pulled from the movable end toward the fixed end to open, or pulled from the fixed end toward the movable end to close and cover the retaining frame and form a storage space.

A foregoing protective cover for motorcycle seat, wherein on the movable end may be disposed a locking device for locking the cover body to the retaining frame.

### BRIEF DESCRIPTION OF THE DRAWINGS

FIG. 1 is a three-dimensional view of the present invention;

FIG. 2 is a planar view of the present invention;

FIG. 3 is a view of the present invention installed on a motorcycle;

FIG. 4 is a view of the present invention in use;

FIG. 5 is another view of the present invention in use.

### DETAILED DESCRIPTION OF THE PREFERRED EMBODIMENTS

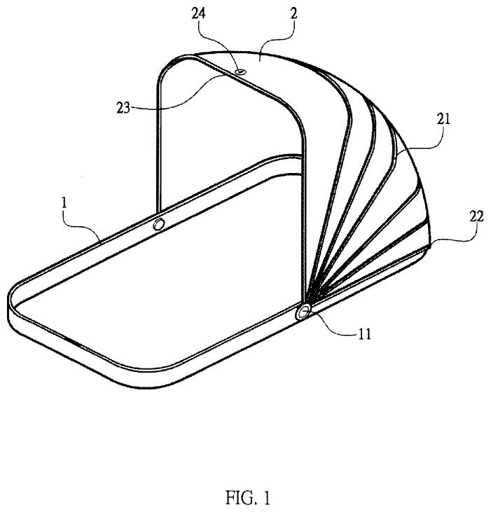

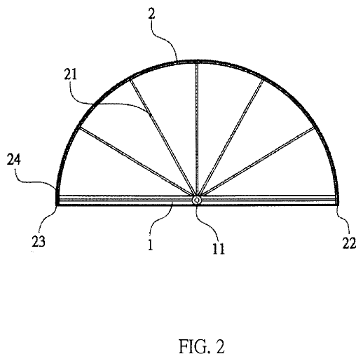

Please refer to both FIG. 1 and FIG. 2, showing respectively a three-dimensional view and a planar view of the present invention. As the Figures show, the present invention comprises a retaining frame 1 and a cover body 2 connected thereto; wherein the retaining frame 1 is arranged according to the shape and size of the motorcycle seat, and the cover body 2 may be of various colors and have various designs; the cover body 2 is of a substantially semi-circular shape thereon are disposed a plurality of support rods 21 that are of a substantially U-shape, and two ends of the plurality of support rods 21 are respectively positioned at central positions of the retaining frame 1 so that the cover body 2 may be pulled toward one end of the retaining frame 1 to open or pulled from that end toward another end to close and cover the retaining frame 1 and form a storage space.

In a preferred embodiment of the present invention, at central positions of two sides of the retaining frame 1 is disposed an axial part 11 fixed on the retaining frame 1. Two ends of the plurality of support rods 21 are respectively positioned at the axial part 11 so that the cover body 2 may use the axial part 11 as a pivot. One end of the cover body 2 is fixed at a fixed end 22 of the retaining frame 1, whereas another end is an open movable end 23 so that the cover body 2 may be pulled from the movable end 23 to the fixed end 22 to open, or pulled from the fixed end 22 to the movable end 23 to close and cover the retaining frame 1 and form a storage space for providing the effects of heat insulation and heat dissipation. Further, on the movable end 23 may be disposed a locking device 24 for locking the cover body 2 to the retaining frame 1.

The foregoing components are combined to form a protective cover for motorcycle seat. The protective cover is fixed on the motorcycle seat by the retaining frame 1. When the motorcycle is not in use, the cover body 2 provides protection against sun, rain and dust, a safe storage space for helmets, and a color that marks out the motorcycle for easy location.

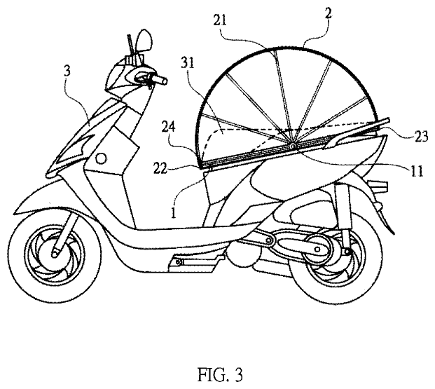

Please refer to FIG. 3, showing a view of the present invention installed on a motorcycle. As the Figure shows, when installed on a motorcycle 3, the protective cover of the present invention and the seat 31 are integrated as a unity by having the retaining frame 1 fixed around the seat 31 of the motorcycle 3 so that the cover body 2 may form a storage space and provide the effects of heat insulation and heat dissipation as well as protection against sun, rain, dust and vandalism.

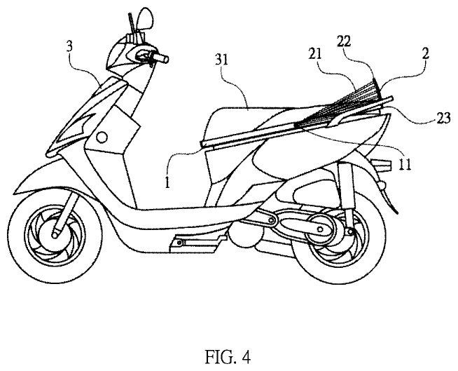

Please refer to FIG. 4, showing a view of the present invention in use. Please also refer to FIG. 1. As the Figures show, when the motorcycle 3 is in use, the cover body 2 may be pulled from the movable end 23 toward the fixed end 22 to open so that the cover body 2 may be collapsed at the fixed end 23 and reveal the seat 31 for riding.

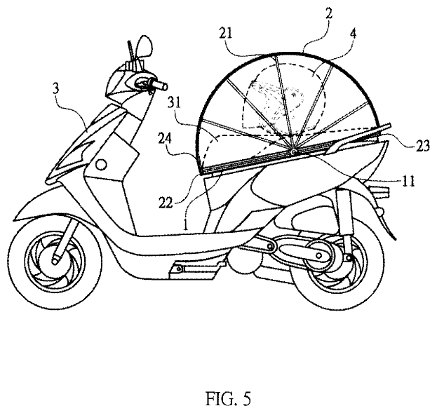

Please refer to FIG. 5, showing another view of the present invention in use. Please also refer to FIG. 1. As the Figures show, when the motorcycle 3 is parked, a helmet 4 and personal items may be placed on the seat 31, and the cover body 2 may be pulled from the fixed end 22 toward the movable end 23 to close and be locked to the retaining frame 1 with a locking device 24 in prevention of theft.

A protective cover for motorcycle seat according to the present invention provides at least the following advantages:

1. It provides the effect of heat insulation, protecting the motorcycle seat from sun damage and the user's hip from burn damage.

2. It provides the effect of rainproof, protecting the seat from rain and the user from having to ride on a wet seat.

3. It provides the effect of dust-proof, protecting the seat from dust pollution and the user from having to ride on a dirty seat.

4. It provides the effect of thief-proof, protecting the helmet and personal items stored under the protective cover against theft.

5. It may be customized with various colors or designs, providing aesthetic effects and the advantage of easy location.

6. It may be used for advertising, providing a space for text and images to achieve the purpose of advertising.

Further, a transmission (a motor or a control circuit) may be additionally disposed at the axial part 11 to manually or remotely drive the axial part 11 to rotate and control the opening or closing of the cover body 2 for achieving the purpose of electric control.

The foregoing preferred embodiments of the present invention are illustrated of the present invention rather than limiting of the present invention. They are intended to cover various modifications and changes included within the spirit and scope of the appended claims, the scope of which should be accorded the broadest interpretation so as to encompass all such modifications and similar structures.

In view of the foregoing, the present invention provides a protective cover for motorcycle seat comprising a cover body that may open or close and a retaining frame attached to the cover body for achieving the purpose of providing protection against sun, rain and dust, a safe storage space for helmets, and a color that marks out the motorcycle for easy location.

What is claimed is:

1. A protective cover for motorcycle seat comprising a retaining frame and a cover body connected thereto; wherein the retaining frame is arranged according to the shape and size of the motorcycle seat for being fixed thereto; the cover body may be pulled to open along the retaining frame or to close and cover the retaining frame and form a storage space, so that when the motorcycle is not in use, the cover body provides protection against sun, rain and dust, and a safe storage space for protecting helmets and personal items from theft.

2. A protective cover for motorcycle seat of claim 1, wherein at central positions of two sides of the retaining frame is disposed an axial part fixed on the retaining frame; wherein on the cover body are disposed a plurality of support rods whose two ends are respectively positioned at the axial part so that the cover body may use the axial part as a pivot; and wherein one end of the cover body is fixed at a fixed end of the retaining frame, and another end is an open movable end so that the cover body may be pulled from the movable end toward the fixed end to open, or pulled from the fixed end toward the movable end to close and cover the retaining frame and form a storage space.

3. A protective cover for motorcycle seat of claim 1, wherein the cover body provides customization with various colors or designs for easy location.

4. A protective cover for motorcycle seat of claim 1, wherein an electrically-operated transmission is additionally disposed at the axial part on the retaining frame to drive the axial part to rotate and control the opening or closing of the cover body for achieving the purpose of electric control.

5. A protective cover for motorcycle seat of claim 1, wherein on the movable end of the cover body is disposed a locking device for locking the cover body to the retaining frame.
